(19) United States
(12) Patent Application Publication
(10) Pub. No.: US 2020/0037181 A1
(43) Pub. Date: Jan. 30, 2020

(54) RADIO FREQUENCY TEST SYSTEM, MEASUREMENT SETUP AS WELL AS METHOD FOR TESTING A DEVICE UNDER TEST

(71) Applicant: Rohde & Schwarz GmbH & Co. KG, Munich (DE)

(72) Inventors: Hendrik Bartko, Unterhaching (DE); Alexander Pabst, Taufkirchen (DE); Adam Tankielun, Ottobrunn (DE); Benoît Derat, Munich (DE)

(73) Assignee: Rohde & Schwarz GmbH & Co. KG, Munich (DE)

(21) Appl. No.: 16/049,211

(22) Filed: Jul. 30, 2018

(51) Int. Cl. H04W 24/06

(52) U.S. Cl. CPC H04W 24/06

(57) ABSTRACT

A radio frequency test system for testing a device under test has a plane wave converter antenna array having a plurality of antennas and several signal distribution networks. Each of the antennas is connected to at least two of the several signal distribution networks, wherein each of the signal distribution networks is configured to feed a signal to be simulated to the plane wave converter antenna array to create a plane wave signal at the device under test having a predefined angle of incidence and a predefined signal magnitude. Further, a measurement setup as well as a method for testing a device under test are shown.

### FIELD OF THE DISCLOSURE

The disclosure relates to a radio frequency test system, a measurement setup and a method for testing a device under test.

### BACKGROUND

In order to guarantee compatibility of devices with specific wireless network environments, over-the-air tests (OTA) of the device under test have to be performed. A radio resource management test (RRM test) for 5G networks is an example of such an OTA test.

In order to perform these tests, the test signals or signals to be simulated need to be plane wave signals at the position of the device under test that correspond to the far-field situation of a base station antenna.

It is known to create such a situation either with a far-field setup, a compact antenna test range (CATR) or a plane wave converter system (PWC system).

All of these systems are very large and expensive. Thus, there is a need for a smaller and less cost-intensive test system.

### SUMMARY

In accordance with one or more aspects of the present disclosure, a radio frequency test system for testing a device under test is provided, having a plane wave converter antenna array having a plurality of antennas and several signal distribution networks, wherein each of the antennas is connected to at least two of the several signal distribution networks. Each of the signal distribution networks is configured to feed a signal to be simulated to the plane wave converter antenna array to create a plane wave signal at the device under test having a predefined angle of incidence and a predefined signal magnitude.

Thus, several different plane wave signals are generated, which simulate signals from different angles of incidence at the position of the device under test. The test system may be used for conducting radio resource management tests, for example for 5G networks.

By using several signal distribution networks for the same plane wave converter antenna array, several different and independent plane wave signals may be generated using a single plane wave converter antenna array. This reduces costs and overall size of the test system, mainly because less hardware is used.

In an aspect of the disclosure, at least two of the signals to be simulated differ in at least one of the angle of incidence and the predefined signal magnitude. This way, several different signals to be simulated may be used for the test.

For example, all signals differ from one another in the angle of incidence and/or signal magnitude.

In an embodiment of the disclosure, each of the antennas is connected to all of the several signal distribution networks so that all signal distribution networks may be used to create plane wave signals originating from every point of the antenna array.

For improved efficiency, the several signal distribution networks are digital signal distribution networks.

In an aspect of the disclosure, at least one of the signal distribution networks comprises at least one phase shifter for each antenna of the plane wave converter antenna array in order to achieve a plane wave signal with the desired properties.

In another aspect of the disclosure, at least one of the signal distribution networks comprises at least one step attenuator for each antenna of the plane wave converter antenna array in order to achieve a plane wave signal with the desired properties.

In an embodiment, the test system comprises at least one signal generator connected to at least one of the signal distribution networks in order to effectively feed the signal distribution network.

In an aspect, at least one signal generator is provided for each of the signal distribution networks leading to an improved quality of the signal to be generated. For example, as many signal generators as signal distribution networks may be provided in the test system.

Additionally or alternatively, the test system comprises at least one signal analyzer connected to at least one of the signal distribution networks to create the desired signal to be analyzed. The signal distribution networks may be fed by the signal analyzer.

In some embodiments, for each of the signal distribution networks at least one signal analyzer is provided increasing signal quality. Therefore, the test system may comprise as many signal analyzers as signal distribution networks.

For above mentioned purpose also a measurement setup is provided, comprising a device under test and a radio frequency test system for testing a device under test having a plane wave converter antenna array having a plurality of antennas and several signal distribution networks. Each of the antennas is connected to at least two of the several signal distribution networks, and each of the signal distribution networks is configured to feed a signal to be simulated to the plane wave converter antenna array to create a plane wave signal at the device under test having a predefined angle of incidence and a predefined signal magnitude.

Further, for above mentioned purpose a method for testing a device under test is provided using a test system having a plane wave converter antenna array with a plurality of antennas and several signal distribution networks, wherein each of the antennas is connected to at least two of the several signal distribution networks. The method comprises the following steps:

feeding several of the signal distribution networks with one signal to be simulated each;

providing each of the several of the signal distribution networks with a predefined angle of incidence and a predefined signal magnitude associated with the signal to be simulated that has been fed to the corresponding signal distribution network; and

driving the antennas by the several of the signal distribution networks creating several plane wave signals at the device under test, each comprising one of the signals to be simulated, and each of the plane wave signals being incident at the device under test with the associated angle of incident and the associated signal magnitude.

In an embodiment, the test setup comprises a shielded chamber in which the device under test and the test system are arranged. This way, the measurement quality is improved even further.

In an aspect, the test setup comprises at least one additional antenna and/or at least one additional antenna array to test the robustness of the device under test.

In some embodiments, the additional antenna and/or the additional antenna array is arranged in the shielded chamber in order to create a network environment with a plurality of signals from additional sources.

For example, the signals to be simulated fed to the several of the signal distribution networks differ from one another.

For an efficient creation of the plane wave signals, the signals to be simulated are fed to the several of the signal distribution networks using a signal generator and/or signal analyzer.

In order to simulate a real-life network efficiently, at least one additional signal is created by an additional antenna and/or an additional antenna array, wherein the additional signal is incident at the device under test.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows schematically a measurement setup according to the disclosure having a radio frequency test system according to the disclosure; and

FIG. 2 shows a flow-chart of a method according to the disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

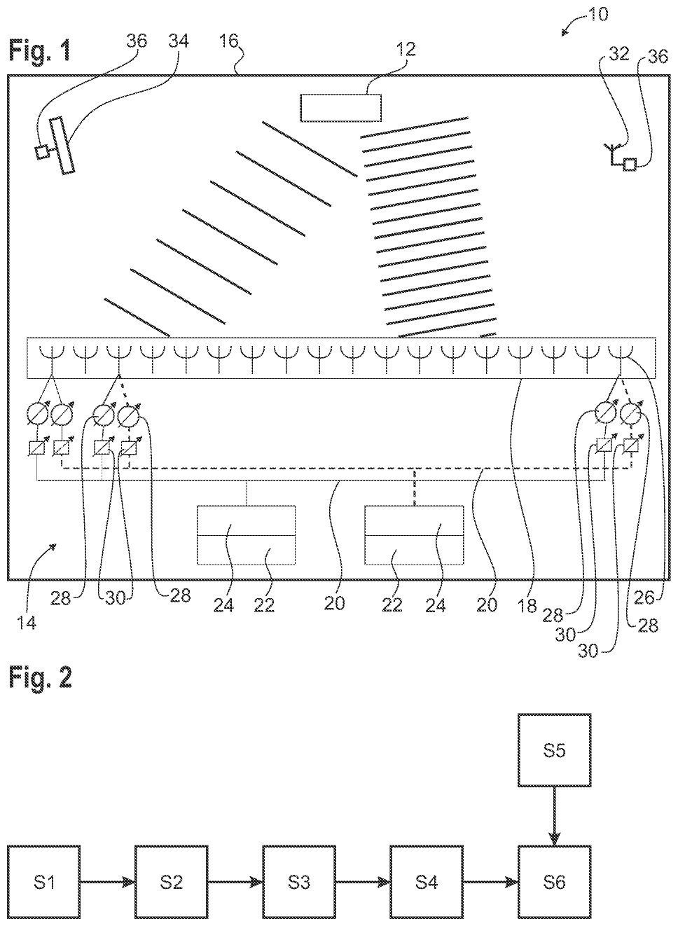

FIG. 1 shows a measurement setup 10 having a device under test 12 and a radio frequency test system 14. The measurement setup 10 may also have a shielded chamber 16, in which the device under test 12 and the radio frequency test system 14 are arranged. The device under test 12 may be a user equipment, like a mobile phone, a tablet or a laptop, an IOT device or even a base station.

The radio frequency test system 14 comprises a plane wave converter antenna array 18, at least two signal distribution networks 20, several signal analyzers 22 and several signal generators 24. In the shown embodiment, two signal distribution networks 20 are shown for simplicity. However, the radio frequency test system 14 may comprise more than two signal distribution networks 20.

The plane wave converter antenna array 18 comprises a plurality of antennas 26 in the shown embodiment. The antennas 26 are arranged in a two-dimensional or three-dimensional setup in a per se known manner in order to create a plane wave signal, i.e. an electromagnetic wave that resembles a plane wave carrying a signal. Each of the antennas 26 is connected to each of the signal distribution networks 20.

The signal distribution networks 20 may be digital signal distribution networks 20 and comprise one phase shifter 28 and one stepped attenuator 30 for each of the antennas 26. In other words, each of the antennas 26 is connected to a phase shifter 28 and a stepped attenuator 30 of each of the signal distribution networks 20.

In FIG. 1 only connections of three different antennas 26 to the signal distribution networks 20 are shown for simplicity. Nevertheless, the remaining antennas 26 are of course also connected to all of the signal distribution networks 20.

For each of the signal distribution networks 20, one of the signal analyzers 22 and one of the signal generators 24 are provided. Thus, there are as many signal analyzers 22 and signal generators 24 provided as signal distribution networks 20 are present. Each of the signal analyzers 22 is connected to one of the signal generators 24 which is in turn connected to the corresponding signal distribution network 20. In some embodiments, the functionality of the signal analyzers 22 is carried out by hardware (e.g., digital circuits, analog circuits, ASICs, microprocessors, combinations thereof, etc.) or software or a combination of hardware and software.

The signal generators 24 and the signal analyzers 22 are used to feed the corresponding signal distribution network 20 with a signal to be simulated. The signal distribution networks 20 are configured to feed the signal to be simulated received from the respective signal generator 24 to the antenna array 18 for generating plane wave signals with a predefined angle of incidence and predefined signal magnitude at the device under test 12.

In addition, an additional antenna 32 and/or an additional antenna array 34 may be part of the radio frequency test system 14 and arranged within the shielded chamber 16. The additional antenna 32 and/or the additional antenna array 34 may comprise an additional signal generator 36 to create signals to be simulated, like disturbing signals.

For testing the device under test 12, the method as illustrated in FIG. 2 is carried out. The tests may be a 5G RRM test carried out over the air (OTA).

In a first step S1, a test scenario is created meaning that various signals to be simulated, e.g. signals that shall be incident at the device under test 12, during the test itself, are defined. The signals to be simulated may be all kinds of signals present in a normal network environment, like protocol messages or content messages.

For each of the signals to be simulated an angle of incidence and a magnitude of the signal of the device under test are predefined. Each of the signals to be simulated differ from one another not only in its content but also in its angle of incidence and magnitude at the device under test 12. As explained before, the different signals are fed to different signal distribution networks. Further, a sequence in time of various signals to be simulated may be defined.

In the next step S2, each of the signals to be simulated is fed to exactly one of the signal distribution networks 20 using the corresponding signal analyzer 22 and signal generator 24.

Further, in step S3, the signal distribution networks 20 are provided with the predetermined angle of incidence and magnitude of the signal to be simulated that is processed by the respective signal distribution network 20.

The signal distribution networks 20 are configured to feed the corresponding signal to be simulated to each of the antennas 26 of the antenna array 18 using the phase shifter 28 and the stepped attenuator 30. Thus, a plane wave or plane wave signal is created by the plane wave converter antenna array 18 in a way that this plane wave signal is incident at the device under test 12 with the predetermined angle of incidence and having the predetermined signal magnitude at the device under test 12 (step S4). Two plane wave signals are illustrated in FIG. 1 that are created using the test system 14.

In other words, each of the signal distribution networks 20 is fed with a specific signal and configured to drive the antennas 26 to create a corresponding plane wave signal based on the predetermined angle of incidence and magnitude of the signal.

At the device under test 12, all of the different signals to be simulated as planned in step S1 are present as different plane wave signals and being incident from different angles of incidence and/or having different signal magnitudes.

At the same time, in step S5, additional signals may be emitted from the additional antenna 32 and/or the additional antenna array 34 to further simulate a real life network environment.

In step S6, during the test, the response of the device under test 12 to the signals to be simulated and the general behavior of the device under test 12 are recorded. Thus, for example a radio resource management test for 5G networks may be carried out efficiently with only a single plane wave converter antenna array.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A radio frequency test system for testing a device under test comprising:
a plane wave converter antenna array having a plurality of antennas arranged in a single plane; and
several signal distribution networks,
wherein each of said antennas is connected to at least two of said several signal distribution networks,
wherein each of said signal distribution networks is configured to feed a signal to be simulated to said plane wave converter antenna array to create a plane wave signal at said device under test having a predefined angle of incidence and a predefined signal magnitude.

2. The radio frequency test system according to claim 1, wherein at least two of said signals to be simulated differ in at least one of said angle of incidence and said predefined signal magnitude.

3. The radio frequency test system according to claim 1, wherein each of said antennas is connected to all of said several signal distribution networks.

4. The radio frequency test system according to claim 1, wherein said several signal distribution networks are digital signal distribution networks.

5. The radio frequency test system according to claim 1, wherein at least one of said signal distribution networks comprises at least one phase shifter for each antenna of said plane wave converter antenna array.

6. The radio frequency test system according to claim 1, wherein at least one of said signal distribution networks comprises at least one step attenuator for each antenna of said plane wave converter antenna array.

7. The radio frequency test system according to claim 1, wherein said test system comprises at least one signal generator connected to at least one of said signal distribution networks.

8. The radio frequency test system according to claim 7, wherein for each of said signal distribution networks at least one signal generator is provided.

9. The radio frequency test system according to claim 1, wherein said test system comprises at least one signal analyzer connected to at least one of said signal distribution networks.

10. The radio frequency test system according to claim 9, wherein for each of said signal distribution networks at least one signal analyzer is provided.

11. A measurement setup comprising:
a device under test; and
a radio frequency test system for testing a device under test having:
a plane wave converter antenna array having a plurality of antennas arranged in a single plane; and
several signal distribution networks,
wherein each of said antennas is connected to at least two of said several signal distribution networks,
wherein each of said signal distribution networks is configured to feed a signal to be simulated to said plane wave converter antenna array to create a plane wave signal at said device under test having a predefined angle of incidence and a predefined signal magnitude.

12. The measurement setup according to claim 11, wherein said test setup comprises an shielded chamber in which said device under test and said test system are arranged.

13. The measurement setup according to claim 11, wherein said test setup comprises at least one of at least one additional antenna and at least one additional antenna array.

14. The measurement setup according to claim 13, wherein at least one of said additional antenna and said additional antenna array is arranged in said shielded chamber.

15. A method for testing a device under test using a test system having a plane wave converter antenna array with a plurality of antennas arranged in a single plane and several signal distribution networks, wherein each of said antennas is connected to at least two of said several signal distribution networks, comprising the following steps:
feeding several of said signal distribution networks with one signal to be simulated each;
providing each of said several of said signal distribution networks with a predefined angle of incidence and a predefined signal magnitude associated with said signal to be simulated that has been fed to said corresponding signal distribution network; and
driving said antennas of the plane wave converter by said several of said signal distribution networks creating several plane wave signals at said device under test, each comprising one of said signals to be simulated, and each of said plane wave signals being incident at said device under test with said associated angle of incident and said associated signal magnitude.

16. The method according to claim 15, wherein said signals to be simulated fed to said several of said signal distribution networks differ from one another.

17. The method according to claim 15, wherein said signals to be simulated are fed to said several of said signal distribution networks using at least one of a signal generator and a signal analyzer.

18. The method according to claim 15, wherein at least one additional signal is created by at least one of an additional antenna and an additional antenna array, wherein said additional signal is incident at said device under test.

19. The method according to claim 15, wherein said test system and said device under test are arranged in a shielded chamber.
